(19) United States
(12) Patent Application Publication
(10) Pub. No.: US 2005/0060524 A1
(43) Pub. Date: Mar. 17, 2005

(54) Processor and methods for micro-operations generation

(76) Inventors: Ittai Anati, Haifa (IL); Gregory Pribush, Beer Sheva (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/663,832

(22) Filed: Sep. 17, 2003

(51) Int. Cl. G06F 9/44

(52) U.S. Cl. 712/245

(57) ABSTRACT

A processor includes an instruction decoder to decode instructions into micro-operations for execution. The instruction decoder may include a programmable logic array to store templates to be addressed by instructions during decoding of the instructions. A collapsed template is addressed by one or more instructions during decoding into fused micro-operations and by one or more instructions during decoding into simple micro-operations. The instruction decoder may also include a multiplexer to select values of a field of the micro-operation based at least on an indication that the instruction being decoded is not being decoded into a simple micro-operation. The instruction decoder may also include a multiplexer to select values of a field of the micro-operation based at least on bits of a template field, where the number of bits of the template field is less than the number of bits of the field of the micro-operation.

### BACKGROUND OF THE INVENTION

A processor may receive instructions to execute, and may comprise an instruction decoder to decode instructions into micro-operations (“u-ops”). The instruction decoder may comprise a programmable logic array (PLA) to generate u-op templates from instructions, and an aliasing mechanism, constructed from a field locator and an alias multiplexers array, to receive the u-op templates, to replace fields of u-op templates with fields extracted directly from the instruction, and to output the u-ops.

The frequency at which a PLA operates may depend upon the area of the PLA and the amount of information stored therein. The frequency at which the PLA operates may affect the ability of the processor as a whole to operate at a desired frequency.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an apparatus comprising a processor having an instruction decoder in accordance with at least one embodiment of the invention; and

FIG. 2 is a block diagram of an apparatus comprising a processor having an instruction decoder in accordance with at least one embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

A processor may receive instructions to execute, and may comprise an instruction decoder to decode instructions into micro-operations (“u-ops”). The instruction decoder may comprise a programmable logic array (PLA) to generate u-op templates from instructions, and an aliasing mechanism, constructed from a field locator and an alias multiplexers array, to receive the u-op templates, to replace fields of u-op templates with fields extracted directly from the instruction, and to output the u-ops. As will be explained hereinbelow, u-ops decoded by the instruction decoder may be “simple” u-ops or “fused” u-ops.

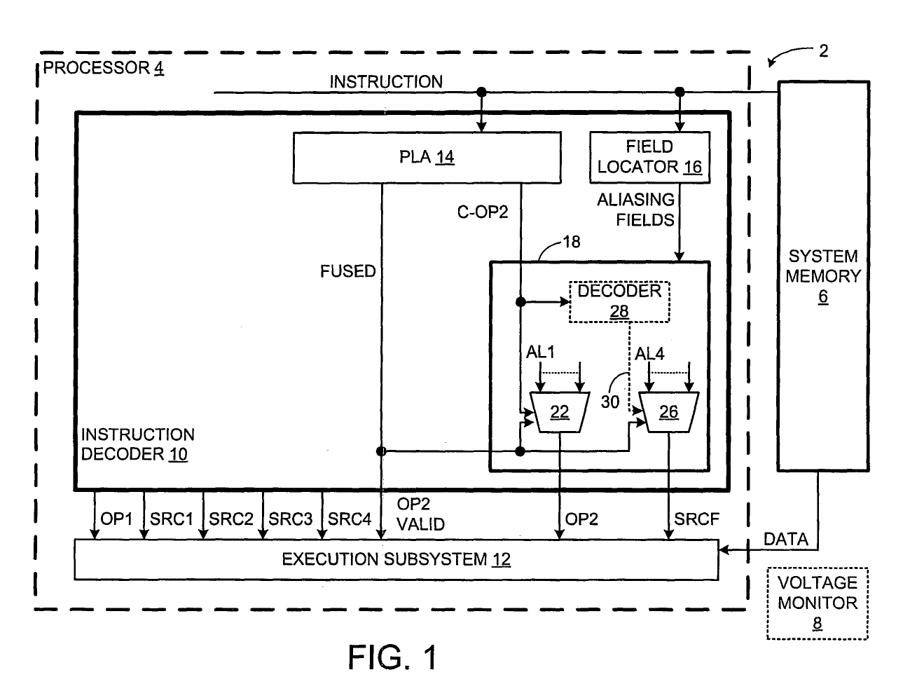

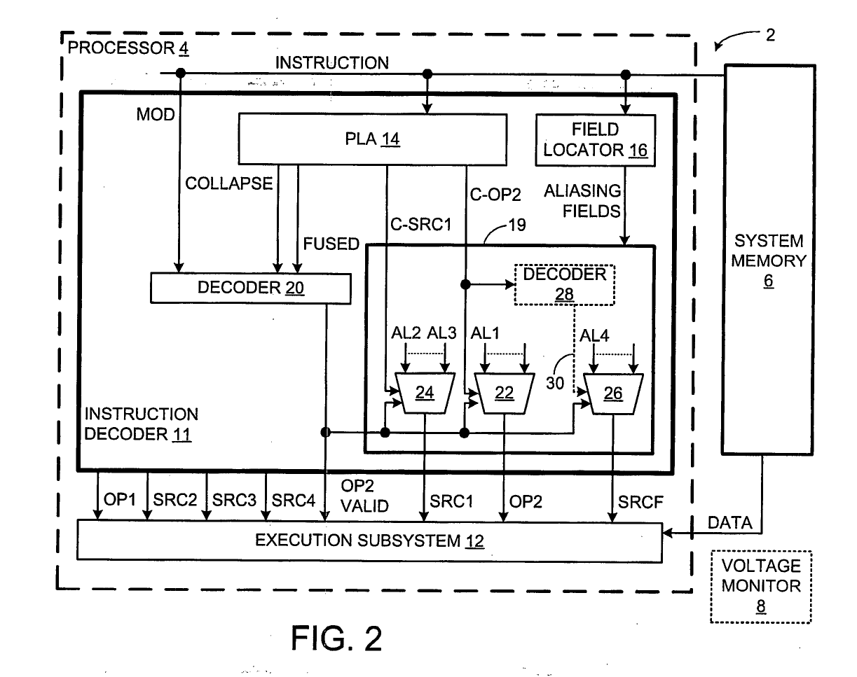

In one embodiment of the invention, which will be explained with respect to FIG. 1, a field of a fused u-op having a particular number of bits may be generated using a u-op template field having a lower number of bits. In another embodiment of the invention, which will be explained with respect to FIG. 1, a field of a fused u-op may be generated without having a respective field in the u-op template. In a further embodiment of the invention, which will be explained with respect to FIG. 2, a fused u-op and a simple u-op may both be generated from the same u-op template. In all of these embodiments, the number of bits stored in the PLA that are used to generate the u-op templates is limited.

Embodiments of the invention will be described for particular examples of an instruction decoder. However, it should be understood that embodiments of the invention may be used in other instruction decoder designs as well.

Embodiments of the present invention may be used in any apparatus having a processor. For example, the apparatus may be a portable device that may be powered by a battery. A non-exhaustive list of examples of such portable devices includes laptop and notebook computers, handheld computers, mobile telephones, personal digital assistants (PDAs), and the like. Alternatively, the apparatus may be a non-portable device, such as, for example, a desktop computer or a server computer.

As shown in FIG. 1, an apparatus 2 may include a processor 4 and a system memory 6, and may optionally include a voltage monitor 8. For clarity, well-known components and circuits of apparatus 2 and of processor 4 are not shown in FIG. 1.

Design considerations, such as, but not limited to, processor performance, cost and power consumption, may result in a particular processor design, and it should be understood that the design of processor 4 shown in FIG. 1 is merely an example and that embodiments of the invention are applicable to other processor designs as well.

A non-exhaustive list of examples for processor 4 includes a central processing unit (CPU), a digital signal processor (DSP), a reduced instruction set computer (RISC), a complex instruction set computer (CISC) and the like. Moreover, processor 4 may be part of an application specific integrated circuit (ASIC) or may be part-of an application specific standard product (ASSP).

A non-exhaustive list of examples for system memory 6 includes a dynamic random access memory (DRAM), a synchronous dynamic random access memory (SDRAM), a flash memory, a double data rate (DDR) memory, RAMBUS dynamic random access memory (RDRAM) and the like. Moreover, system memory 6 may be part of an application specific integrated circuit (ASIC) or may be part of an application specific standard product (ASSP).

System memory 6 may store instructions to be executed by processor 4. System memory 6 may also store data for the instructions, or the data may be stored elsewhere. An instruction decoder 10 may receive instructions from system memory 6, and may decode those instructions into u-ops. An execution subsystem 12 may receive the u-ops from instruction decoder 10 and may receive the data for those u-ops from system memory 6 or elsewhere, and may execute the u-ops.

A u-op may comprise one or more sources and one or more op-codes, where “op-code” is a field of the u-op defining an operation to be performed on “operands”, and “source” is a field of the u-op that may contain an operand or may point to a location where an operand may be found.

The physical traces used to carry u-ops from instruction decoder 10 to execlution subsystem 12 may comprise a number of signal groups.

In the exemplary processor of FIG. 1, there are two signal groups (denoted “OP1” and “OP2”) to optionally carry op-codes, five signal groups (denoted “SRC1”, “SRC2”, “SRC3”, “SRC4” and “SRCF”) to optionally carry sources, and one signal group (denoted “OP2 VALID”) for indicating whether signal group “OP2” carries an op-code. The exemplary processor of FIG. 1 may comprise additional signal groups to optionally carry fields of u-ops, however for clarity these additional signal groups have not been described.

“Simple” U-ops and “Fused” U-ops

Instruction decoder 10 may decode instructions into “simple” u-ops, and may decode instructions into “fused” u-ops.

In the exemplary design of processor 4, a “simple” u-op is a u-op that includes a single op-code. When instruction decoder 10 outputs a simple u-op, the “OP1” signal group may carry the op-code. In addition, signal group “OP2 VALID” may carry a value, for example the value “0”, to indicate that signal group “OP2” does not carry an op-code.

For example, a first group of instructions may define an “add” operation between two registers. The general form of instructions of the first group of instructions is shown in (1), and a particular example is shown in (1.a):
(1) add reg1, reg2
(1.a) add eax, ebx

Instruction (1) may instruct processor 4 to perform an add operation between the value stored in the register defined in the “reg2” field and the value stored in the register defined in the “reg1” field, and to store the result in the register defined in the “reg1” field.

Instruction decoder 10 may decode instructions that belong to the first group of instructions into simple u-ops. When instruction decoder 10 outputs a simple u-op decoded from instruction (1), the physical traces used to carry u-ops from instruction decoder 10 to execution subsystem 12 may carry the values in the general form shown below in TABLE 1 at instruction (1.b). In the particular example of instruction (1.a), the “reg1” field defines a register named “eax”, and the “reg2” field defines a register named “ebx”, as shown below in TABLE 1 at instruction (1.c).

TABLE 1

| | OP2 VALID | OP1 | OP2 | SRC1 | SRC2 | SRC3 | SRC4 | SRCF |
|---|---|---|---|---|---|---|---|---|
| (1.b) | 0 | add | — | reg1 | reg2 | — | — | — |
| (1.c) | 0 | add | — | eax | ebx | — | — | — |

In the exemplary design of processor 4, a “fused” u-op is a u-op that combines the operations of two simple u-ops and includes two op-codes, one for each operation. When instruction decoder 10 outputs a fused u-op, the “OP1” signal group may carry one op-code, and the “OP2” signal group may carry the other op-code. In addition, signal group “OP2 VALID” may carry a value, for example the value “1”, to indicate that signal group “OP2” carries an op-code.

It should be noted that in other processor designs, a fused u-op may combine the operations of two or more simple u-ops and may include two or more op-codes.

For example, a second group of instructions may define an “add” operation between one register and a value stored in a memory location. The general form of instructions of the second group of instructions is shown in (2), and a particular example is shown in (2.a):
(2) add reg1, dword ptr[base+index*scale]+disp
(2.a) add eax, dword ptr[ecx+edx*2]+FF2A

Instruction (2) may instruct processor 4 to load a value from a memory location defined by the fields “base”, “index”, “scale” and “disp”, to perform an add operation between that value and the value stored in the register defined in the “reg1” field, and to store the result in the register defined in the “reg1” field. The “index” and “base” fields of instruction (2) specify registers, which store the address space, the address index and address base values, respectively. The “scale” and “disp” fields of instruction (2) specify an address scaling factor and an address displacement, respectively.

Instruction decoder 10 may decode instructions that belong to the second group of instructions into fused u-ops. When instruction decoder 10 outputs a fused u-op decoded from instruction (2), the physical traces used to carry u-ops from instruction decoder 10 to execution subsystem 12 may carry the values in the general form shown below in TABLE 2 at instruction (2.b). In the particular example of instruction (2.a), the “reg1” field defines a register named “eax”, the “base” field defines a register named “ecx”, the “index” field defines a register named “edx”, the “disp” field defines the value FF2A, and the “scale” field defines the number 2, as shown below in TABLE 2 at instruction (2.c).

The “OP2” signal group may carry the op-code “load”, which is common to all instructions of the second group of instructions.

TABLE 2

| | OP2 VALID | OP1 | OP2 | SRC1 | SRC2 | SRC3 | SRC4 | SRCF |
|---|---|---|---|---|---|---|---|---|
| (2.b) | 1 | add | load | base | reg1 | disp | scale | index |
| (2.c) | 1 | add | load | ecx | eax | FF2A | 2 | edx |

Structure of Exemplary Instruction Decoder of FIG. 1

Instruction decoder 10 may comprise a programmable logic array (PLA) 14, a field locator 16, and an alias multiplexers group 18. Alias multiplexers group 18 may comprise multiplexers 22 and 26, and may optionally comprise a decoder 28. The output of multiplexers 22 and 26 are the signal groups OP2 and SRCF, respectively. Instruction decoder 10 may further comprise additional multiplexers, decoders or other logic elements, which for clarity are not shown in FIG. 1.

Aliasing Fields

Field locator 16 may receive instructions as input, and for a received instruction, field locator 16 may output a group of fields denoted “aliasing fields”. An aliasing field may comprise bits that field locator 16 extracts directly from the instruction and/or bits that are encoded from the instruction and the architectural machine state. Additionally, an aliasing field may comprise bits derived from a field of a u-op template generated by PLA 14 (described below). A non-exhaustive list of examples of the content of an aliasing field includes a logical register, a code address size, a data address size, a data size, a stack address, a stack address size, immediate, scale and displacement data, branch information and a portion of various op-codes. In the exemplary processor of FIG. 1, field locator 16 may generate two aliasing fields, denoted “AL1” and “AL4”. Field locator 16 may generate additional aliasing fields, however for clarity these additional aliasing fields have not been described.

When instruction decoder 10 receives an instruction from the first group of instructions, “AL1” and “AL4” may not carry relevant information.

When instruction decoder 10 receives an instruction from the second group of instructions, “AL1” may carry the op-code “load”. In the example of instruction (2.a), “AL1” may carry the op-code “load_with_scale_2”, while “AL4” may carry the values of the parameter “index”.

For clarity, the information carried by the aliasing fields “AL1” and “AL4” when instruction decoder 10 receives an instruction from the first group of instructions and when instruction decoder 10 receives an instruction from the second group of instructions is summarized in TABLE 3:

TABLE 3

Aliasing field

| | AL1 | AL4 |
|---|---|---|
| First group of instructions | — | — |
| Second group of instructions | load_with_scale_2 | index |

U-op Templates

PLA 14 may store u-op templates. PLA 14 may receive instructions as input, and for a received instruction, PLA 14 may output a particular u-op template. It should be noted that the same u-op template may be addressed by more than one instruction.

A u-op template may comprise fields that explicitly or implicitly define fields of the u-op. In the exemplary processor of FIG. 1, a u-op template may comprise a field (denoted “C-OP2”) that may explicitly or implicitly define the “OP2” signal group and a field denoted “FUSED” that may explicitly or implicitly define the “OP2 VALID” signal group. The u-op template may comprise additional fields. however for clarity these additional fields are not shown in FIG. 1.

In the exemplary processor of FIG. 1, PLA 14 may comprise at least two types of u-op templates:
a) A “simple template” may be addressed to generate simple u-ops. The “FUSED” field of a simple template may have the value “0”, for example.
b) A “fused template” may be addressed to generate fused u-ops. The “FUSED” field of a fused template may have the value “1”, for example.

TABLE 4 summarizes the field content of the simple template and the fused template.

TABLE 4

| | FUSED | C-OP2 |
|---|---|---|
| simple template | 0 | — |
| fused template | 1 | load |

Determination of “OP2” Signal Group

In the exemplary processor of FIG. 1, multiplexer 22 may receive on physical traces control input signals and one or more groups of data input signals. A value presented on the control input signals of multiplexer 22 determines the value of which group of data input signals of multiplexer 22 may be outputted from multiplexer 22 into the “OP2” signal group.

Multiplexer 22 may receive some of its control input signals from bits of the C-OP2 field and some of its control input signals from bits of the “OP2 VALID” signal group. In addition, multiplexer 22 may receive a first group of data input signals from bits of the “AL1” aliasing field.

In an exemplary embodiment of the invention, the instructions of the first group of instructions may all address the same simple template, and the instructions of the second group of instructions may all address the same fused template.

When instruction decoder 10 receives an instruction of the first group of instructions, PLA 14 outputs the simple template, which has the value “0” for the “FUSED” field. Therefore, the “OP2 VALID” signal group carries the value “0”, and the value output by multiplexer 22 to be carried by the “OP2” signal group will be ignored by execution subsystem 12.

When instruction decoder 10 receives an instruction of the second group of instructions, PLA 14 outputs the fused template, which has the value “1” for the “FUSED” field. Therefore, the “OP2 VALID” signal group carries the value “1”. Having the value “1” carried by the “OP2 VALID” signal group and the value “load” in the C-OP2 field may result in multiplexer 22 outputting the value of the first group of data input signals into the “OP2” signal group.

In a specific example, the C-OP2 field may comprise a number of bits that implicitly define the op-code “load”, and the “AL1” field and the output of multiplexer 22 may comprise a larger number of bits that provide a fall representation of the op-code “load”.

Consequently, a field (e.g. OP2) of a fused u-op having a particular number of bits may be generated using a u-op template field (e.g. C-OP2) having a lower number of bits.

Moreover, if PLA 14 stores two or more u-op templates that are addressed during decoding of instructions into fused u-ops, then the number of bits in each of the u-op templates that are used to select values for a particular field of the fused u-ops may be less than the maximal number of bits in that particular field.

Determination of “SRCF” Signal Group

In the exemplary processor of FIG. 1, multiplexer 26 may receive on physical traces control input signals and one or more groups of data input signals. A value presented on the control input signals of multiplexer 26 determines the value of which group of data input signals of multiplexer 26 may be outputted from multiplexer 26 into the “SRCF” signal group.

Multiplexer 26 may receive some of its control input signals from bits of the “OP2 VALID” signal group. In addition, multiplexer 26 may receive a first group of data input signals from bits of the “AL4” aliasing field.

Having the value “1” in the “OP2 VALID” signal group may result in multiplexer 26 outputting the value of the first group of data input signals (bits of the “AL4” aliasing field) into the “SRCF” signal group. In the example of instructions from the second group of instructions, this value is “index”. Having the value “0” in the “OP2 VALID” signal group may result in multiplexer 26 outputting into the “SRCF” signal group a value that is ignored by execution subsystem 12.

As shown above, for instructions of the second group of instructions the value of the “OP2 VALID” signal group is sufficient for selecting bits of aliasing field “AL4” to be outputted to the “SRCF” signal group. However, other instructions to be decoded into fused u-ops yet which do not belong to the second group of instructions may require other aliasing fields to be outputted to the “SRCF” signal group. Therefore, optional decoder 28 may decode the C-OP2 field and possibly other information to generate an optional group of signals 30 that together with the “OP2 VALID” signal group may control multiplexer 26 to select the appropriate aliasing field for each of these instructions. In another embodiment, optional decoder 28 may decode a field of the u-op template used to generate an operand of a u-op.

Consequently a field (e.g. SRCF) of a fused u-op may be generated without having a respective field in the u-op template (e.g. there is no C-SRCF field in the u-op template).

Structure of Exemplary Instruction Decoder of FIG. 2

FIG. 2 is similar to FIG. 1 and elements in common will not be described in further detail. An instruction decoder 11 may differ from instruction decoder 10 of FIG. 1. For example, instruction decoder 11 may comprise an alias multiplexers group 19 in place of alias multiplexers group 18 of FIG. 1. Alias multiplexers group 19 may comprise multiplexers 22, 24 and 26, and may optionally comprise decoder 28. The output of multiplexer 24 is the signal group SRC1. Moreover, instruction decoder 11 may comprise a decoder 20, which will be described in more detail hereinbelow. Furthermore, PLA 14 may output u-op templates having fields that were not described with respect to FIG. 1. Additionally, field locator 16 may output aliasing fields that were not described with respect to FIG. 1. Instruction decoder 11 may further comprise additional multiplexers, decoders or other logic elements, which for clarity are not shown in FIG. 2.

Aliasing Fields

In the exemplary processor of FIG. 2, field locator 16 may generate four aliasing fields, denoted “AL1”, “AL2”, “AL3” and “AL4”. Field locator 16 may generate additional aliasing fields, however for clarity these additional aliasing fields have not been described.

When instruction decoder 11 receives an instruction from the first group of instructions, “AL2” may carry an identifier of the register in the “reg1” fields of the instruction. In the example of instruction (1.a), “AL2” may carry the register identifier “eax”, while “AL1”, “AL3” and “AL4” may not carry relevant information

When instruction decoder 11 receives an instruction from the second group of instructions, “AL1” may carry the op-code “load”. In the example of instruction (2.a), “AL1” may carry the op-code “load_with_scale_2”, while “AL3” and “AL4” may carry the values of the parameters “base” and “index”, respectively, and “AL2” may not carry relevant information.

For clarity, the information carried by the aliasing fields when instruction decoder 11 receives an instruction from the first group of instructions and when instruction decoder 11 receives an instruction from the second group of instructions is summarized in TABLE 5:

TABLE 5

| | Aliasing field | | | |
|---|---|---|---|---|
| | AL1 | AL2 | AL3 | AL4 |
| First group of instructions | — | reg1 | — | — |
| Second group of instructions | load_with_scale_2 | — | base | index |

U-op Templates

A u-op template may comprise fields that explicitly or implicitly define fields of the u-op. In the exemplary processor of FIG. 2, a u-op template may comprise a field (denoted “C-OP2”) that may explicitly or implicitly define the “OP2” signal group, a field denoted “COLLAPSE” and a field denoted “FUSED” that together with a group of bits denoted, for example, “MOD” extracted directly from the instruction may explicitly or implicitly define the “OP2 VALID” signal group. The u-op template may comprise additional fields, however for clarity these additional fields are not shown in FIG. 2.

In the exemplary processor of FIG. 2, PLA 14 may comprise at least three types of u-op templates: simple templates, fused templates and “collapsed templates”. A “collapsed template” may be addressed to generate both fused and simple u-ops. The “FUSED” field of a collapsed template may have the value “0”, for example, and the “COLLAPSE” field of a collapsed template may have the value “1”, for example. In contrast, the “COLLAPSE” field of a simple template or a fused template may have the value “0”.

Decoder 20 may receive the “COLLAPSE” and “FUSED” u-op template fields from PLA 14, may additionally receive the “MOD” bits directly from the instruction, and may generate the “OP2 VALID” signal group. For a simple template or a fused template, decoder 20 may ignore the “MOD” bits and may generate the “OP2 VALID” signal group according to the value of the “FUSED” u-op template field.

In an exemplary embodiment of the present invention, PLA 14 may include a collapsed template to be addressed by instructions of both the first and second groups of instructions.

When instruction decoder 11 receives an instruction of the first group of instructions or an instruction of the second group of instructions, PLA 14 may output the same collapsed template. For a collapsed template, decoder 20 may output a value on the “OP2 VALID” signal group according to the value of the “MOD” bits.

The value of the “MOD” bits of an instruction from the first group of instructions may have a binary value, for example “11”, indicating an operation between two registers. Consequently, decoder 20 may output the value “0” on the “OP2 VALID” signal group to indicate that instruction decoder 11 outputs a simple u-op and that the “OP2” signal group does not carry an op-code.

However, the value of the “MOD” bits of an instruction from the second group of instructions may have a binary value, for example not “11”, indicating an operation between a register and a memory location. Consequently, decoder 20 may output the value “1” on the “OP2 VALID” signal group to indicate that instruction decoder 10 outputs a fused u-op and that the “OP2” signal group carries an op-code.

TABLE 6 summarizes the field content of the simple template, the fused template and the collapsed template.

TABLE 6

| | COLLAPSE | FUSED | C-OP2 | C-SRC1 |
|---|---|---|---|---|
| simple template | 0 | 0 | — | src1 |
| fused template | 0 | 1 | load | base |
| collapsed template | 1 | 0 | | |

Determination of “OP2” Signal Group

The determination of the “OP2” signal group via control input signals for multiplexer 22 may occur as described hereinabove with respect to FIG. 1, with the difference that the value on the “OP2 VALID” signal group is determined by decoder 20 and not directly by the value of the “FUSED” u-op template field.

Determination of “SRCF” Signal Group

The determination of the “SRCF” signal group via control input signals for multiplexer 26 may occur as described hereinabove with respect to FIG. 1, with the difference that the value on the “OP2 VALID” signal group is determined by decoder 20 and not directly by the value of the “FUSED” u-op template field.

Determination of “SRC1” Signal Group

In the exemplary processor of FIG. 2, multiplexer 24 may receive on physical traces control input signals and two or more groups of data input signals. A value presented on the control input signals of multiplexer 24 determines the value of which group of data input signals of multiplexer 24 may be outputted from multiplexer 24 into the “SRC1” signal group.

The value carried by the “SRC1” signal group for a simple u-op may differ from that for a fused u-op. If the simple u-op and the fused u-op are generated from the same collapsed template, then additional information may be needed in order to determine from which group of data input signals multiplexer 24 is to output a value to be carried by the “SRC1” signal group. As will now be described, that additional information is provided by the “OP2 VALID” signal group and bits of the C-SRC1 field.

Multiplexer 24 may receive some of its control input signals from bits of the C-SRC1 field and some of its control input signals from bits of the “OP2 VALID” signal group. In addition, multiplexer 24 may receive a first group of data input signals from bits of the “AL2” aliasing field and a second group of data input signals from bits of the “AL3” aliasing field.

When instruction decoder 11 receives an instruction of the first group of instructions, PLA 14 may output the collapsed template, and the value of the “MOD” bits is “11”. Therefore, the “OP2 VALID” signal group has the value “0”. Having the value “0” in the “OP2 VALID” signal group and the value “reg1” in the C-SRC1 field may result in multiplexer 24 outputting the value of the first group of data input signals (namely “reg1”) into the “SRC1” signal group. A similar result would have occurred if the instruction of the first group of instructions addressed a simple template in PLA 14.

When instruction decoder 11 receives an instruction of the second group of instructions, PLA 14 may output the collapsed u-op template, and the value of the “MOD” bits is different from “11”. Therefore, the “OP2 VALID” signal group has the value “1”. Having the value “1” in the “OP2 VALID” signal group and the value “base” in the C-SRC1 field may result in multiplexer 24 outputting the value of the second group of data input signals of multiplexer 24 (namely “base”) into the “SRC1” signal group. A similar result would have occurred if the instruction of the second group of instructions addressed a fused template in PLA 14.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
selecting values for a field of a micro-operation based at least upon bits of a field of a micro-operation template, wherein the number of said bits is fewer than the number of bits in said field of said micro-operation.

2. The method of claim 1, wherein selecting said values includes selecting said values if said micro-operation is a fused micro-operation.

3. The method of claim 2, wherein selecting said values includes selecting said values for an op-code of said micro-operation.

4. A method comprising:
generating micro-operation templates for micro-operations, said templates including bits to be used to select values for a particular field of said micro-operations, wherein the number of said bits in said templates is smaller than the maximal number of bits of said particular field.

5. The method of claim 4, wherein said particular field is an op-code.

6. The method of claim 4, wherein said micro-operations are fused micro-operations.

7. A method comprising:
decoding an instruction into a fused micro-operation, including selecting values of a field of said fused micro-operation based solely upon an indication that said instruction is not being decoded into a simple micro-operation.

8. The method of claim 7, further comprising:
generating said indication for said instruction from one or more fields of a micro-operation template.

9. The method of claim 7, wherein selecting values of said field includes selecting values of an operand of said fused micro-operation.

10. A method comprising:
decoding an instruction into a fused micro-operation, including selecting values of a first field of said fused micro-operation based solely upon an indication that said instruction is not being decoded into a simple micro-operation and a value decoded from a field of a micro-operation template that is used to select values of a second field of said fused micro-operation.

11. The method of claim 10, wherein said first field is an operand of said fused micro-operation.

12. The method of claim 10, wherein said second field is an op-code of said fused micro-operation.

13. A method comprising:
decoding a field of a micro-operation template that is used to select values of a field of a fused micro-operation in order to distinguish between different micro-operation templates that are addressed by instructions during decoding of said instructions into fused micro-operations.

14. The method of claim 13, wherein said field of said fused micro-operation is an op-code of said fused micro-operation.

15. The method of claim 13, wherein said field of said fused micro-operation is an operand of said fused micro-operation.

16. A method comprising:
addressing a micro-operation template by one or more instructions to be decoded into one or more fused micro-operations and by one or more instructions to be decoded into one or more simple micro-operations.

17. The method of claim 16, further comprising:
generating for a particular instruction that addresses said micro-operation template an indication whether said particular instruction is to be decoded into a fused micro-operation or into a simple micro-operation.

18. The method of claim 17, wherein generating said indication comprises generating said indication from one or more fields of said micro-operation template and from bits extracted directly from said particular instruction.

19. A method comprising:
selecting values of a field of a micro-operation from a first set of physical traces if said micro-operation is simple and from a second set of physical traces if said micro-operation is fused, where said micro-operation is generated from a micro-operation template that is addressed by one or more instructions to be decoded into one or more fused micro-operations and by one or more instructions to be decoded into one or more simple micro-operations.

20. The method of claim 19, wherein selecting said values comprises selecting said values based at least upon an indication whether an instruction from which said micro-operation is being decoded is being decoded into a fused micro-operation or into a simple micro-operation.

21. The method of claim 19, wherein said field is an operand of said micro-operation.

22. A processor to execute instructions, the processor comprising:
an instruction decoder including at least:
a programmable logic array to store a micro-operation template to be addressed by an instruction during decoding of said instruction into a fused micro-operation having a particular field; and
a multiplexer to select values for said particular field based at least upon bits of a field of said micro-operation template, wherein the number of said bits is fewer than the number of bits in said particular field.

23. The processor of claim 22, wherein said particular field is an op-code of said fused micro-operation.

24. The processor of claim 22, wherein said multiplexer is to select values for said particular field also based upon an indication that said instruction is not being decoded into a simple micro-operation.

25. A processor to execute instructions, the processor comprising:
an instruction decoder including at least:
a programmable logic array to store a micro-operation template to be addressed by an instruction during decoding of said instruction into a fused micro-operation having a particular field; and
a multiplexer to select values for said particular field based solely upon an indication that said instruction is not being decoded into a simple micro-operation.

26. The processor of claim 25, wherein said particular field is an operand of said fused micro-operation.

27. The processor of claim 25, wherein said indication comprises bits of a field of said micro-operation template.

28. The processor of claim 25, wherein said instruction decoder further comprises:
a decoder to generate said indication from two or more fields of said micro-operation template and from bits extracted directly from said instruction.

29. A processor to execute instructions, the processor comprising:
an instruction decoder including at least:
a programmable logic array to store a micro-operation template to be addressed by an instruction during decoding of said instruction into a fused micro-operation having a particular field;
a decoder to decode a value from a field of said micro-operation template; and
a multiplexer to select values for said particular field based solely upon said value and an indication that said instruction is not being decoded into a simple micro-operation.

30. The processor of claim 29, wherein said field of said micro-operation template is used to select values of an op-code of said fused micro-operation.

31. The processor of claim 29, wherein said particular field is an operand of said fused micro-operation.

32. The processor of claim 29, wherein said indication comprises bits of another field of said micro-operation template.

33. The processor of claim 29, wherein said instruction decoder further comprises:
a decoder to generate said indication from two or more additional fields of said micro-operation template and from bits extracted directly from said instruction.

34. A processor to execute instructions, the processor comprising:
an instruction decoder including at least:
a programmable logic array to store a micro-operation template to be addressed by one or more instructions that are to be decoded into one or more fused micro-operations and by one or more instructions that are to be decoded into one or more simple micro-operations.

35. The processor of claim 34, wherein said micro-operation template includes a field having a value that identifies that both a fused micro-operation and a simple micro-operation can be generated from said micro-operation template.

36. The processor of claim 34, wherein said instruction decoder further comprises:
a decoder to generate an indication for a particular instruction from two or more fields of said micro-operation template and from bits extracted directly from said particular instruction, wherein said indication is an indication whether said particular instruction is to be decoded into a fused micro-operation or into a simple micro-operation.

37. An apparatus comprising:
a voltage monitor; and
a processor to execute instructions, the processor comprising:
an instruction decoder including at least:
a programmable logic array to store a micro-operation template to be addressed by an instruction during decoding of said instruction into a fused micro-operation having a particular field; and
a multiplexer to select values for said particular field based at least upon bits of a field of said micro-operation template, wherein the number of said bits is fewer than the number of bits in said particular field.

38. The apparatus of claim 37, wherein said particular field is an op-code of said fused micro-operation.

39. The apparatus of claim 37, wherein said multiplexer is to select values for said particular field also based upon an indication that said instruction is not being decoded into a simple micro-operation.

40. An apparatus comprising:
a voltage monitor; and
a processor to execute instructions, the processor comprising:
an instruction decoder including at least:
a programmable logic array to store a micro-operation template to be addressed by an instruction during decoding of said instruction into a fused micro-operation having a particular field; and
a multiplexer to select values for said particular field based solely upon an indication that said instruction is not being decoded into a simple micro-operation.

41. The apparatus of claim 40, wherein said particular field is an operand of said fused micro-operation.

42. The apparatus of claim 40, wherein said indication comprises bits of a field of said micro-operation template.

43. The apparatus of claim 40, wherein said instruction decoder further comprises:
a decoder to generate said indication from two or more fields of said micro-operation template and from bits extracted directly from said instruction.

44. An apparatus comprising:
a voltage monitor; and
a processor to execute instructions, the processor comprising:
an instruction decoder including at least:
a programmable logic array to store a micro-operation template to be addressed by an instruction during decoding of said instruction into a fused micro-operation having a particular field;
a decoder to decode a value from a field of said micro-operation template; and
a multiplexer to select values for said particular field based solely upon said value and an indication that said instruction is not being decoded into a simple micro-operation.

45. The apparatus of claim 44, wherein said field of said micro-operation template is used to select values of an op-code of said fused micro-operation.

46. The apparatus of claim 44, wherein said particular field is an operand of said fused micro-operation.

47. The apparatus of claim 44, wherein said indication comprises bits of another field of said micro-operation template.

48. The apparatus of claim 44, wherein said instruction decoder further comprises:
a decoder to generate said indication from two or more additional fields of said micro-operation template and from bits extracted directly from said instruction.

49. An apparatus comprising:
a voltage monitor; and
a processor to execute instructions, the processor comprising:
an instruction decoder including at least:
a programmable logic array to store a micro-operation template to be addressed by one or more instructions that are to be decoded into one or more fused micro-operations and by one or more instructions that are to be decoded into one or more simple micro-operations.

50. The apparatus of claim 49, wherein said micro-operation template includes a field having a value that identifies that both a fused micro-operation and a simple micro-operation can be generated from said micro-operation template.

51. The apparatus of claim 49, wherein said instruction decoder further comprises:
a decoder to generate an indication for a particular instruction from two or more fields of said micro-operation template and from bits extracted directly from said particular instruction, wherein said indication is an indication whether said particular instruction is to be decoded into a fused micro-operation or into a simple micro-operation.
